(19) United States
(12) Patent Application Publication
(10) Pub. No.: US 2008/0110955 A1
(43) Pub. Date: May 15, 2008

(54) Method of Operating a Gathering Stapler with Separate Drives

(75) Inventors: Lutz Richter, Schkeuditz (DE); Andreas Steinert, Leipzig (DE); Siegmar Tischer, Borsdorf (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 12/017,850

(22) Filed: Jan. 22, 2008

Related U.S. Application Data
(62) Division of application No. 09/852,348, filed on May 9, 2001, now abandoned.

(30) Foreign Application Priority Data
May 9, 2000 (DE) 100 22 323.0
Nov. 27, 2000 (DE) 100 58 796.8

(51) Int. Cl. B27F 7/00

(52) U.S. Cl. 227/110

(57) ABSTRACT

A method of driving a gathering stapler having a plurality of subassemblies including a stapling carriage, a collecting chain, a stapling-displacement configuration, a delivery, and an ejector. The method includes separately driving at least two of the subassemblies, each with a separately controllable drive. Commanding movements of the subassemblies driven in each case by controllable motors, with an electronic control unit. Synchronizing a movement of one separately driven subassembly with a movement of at least one other separately driven subassembly. Executing a variable collecting-chain movement adapted to a simultaneous operation of the stapling carriage.

### CROSS-REFERENCE TO RELATED APPLICATIONS

This is a divisional application of application Ser. No. 09/852,348, filed May 9, 2001; the application also claims the priority, under 35 U.S.C. §119, of German patent applications DE 100 22 323.0, filed May 9, 2000, and DE 100 58 796.8, filed Nov. 27, 2000; the prior applications are herewith incorporated by reference in their entirety.

### BACKGROUND OF THE INVENTION

### Field of the Invention

The invention relates to a gathering stapler which has at least the following subassemblies: collecting chain, stapling carriage, stapling-displacement configuration, ejector, and delivery.

Gathering staplers are paper-processing machines by means of which a product, for example a brochure, is put together from a plurality of folded sheets and stapled. Lying on folded-sheet feeders or standing on the spine, printed folded sheets, separated from stacks, are fed, opened and positioned on a collecting chain. The number of folded sheets which is to be stapled is collected, and aligned, on the collecting chain by carry-along elements. The collecting chain transports the collected folded sheets to a stapling arrangement, where the sheets are provided with staples by stapling heads. In order to trim the edge of the stapled products, a so-called trimmer is usually provided following the ejecting operation, the end products being transported further from the trimmer to a delivery.

In gathering staplers, use may expediently be made of two stapling principles, namely, stapling at a standstill or stapling with the product moving.

In order to carry out stapling at a standstill, the product must first be stopped. The disadvantage here is that disruptive influences during the deceleration and the acceleration of the movement may cause the product to alter its position. In order to carry out stapling with the product moving, it is necessary for the stapling arrangement, comprising stapling carriage and bending arrangement, to be moved along with the product which is to be stapled and to be coordinated at least temporarily with the movement of the product. The gathering stapler is driven by a central electric motor. In that case, the various subassemblies, such as the stapling apparatus (stapling carriage and bending arrangement), the collecting chain, the folded-sheet feeder, the trimmer (three-knife trimmer) and possibly further components, are driven via various gear mechanisms and a continuous shaft, a so-called vertical shaft. In other words, the collecting chain, the stapling carriage and the stapling elements are driven by means of a common drive shaft and by way of a common power source, but are provided with separate drive mechanisms for producing the various movements. It is also the case that conventional gathering staplers which have a stapling carriage, operating simultaneously with a collecting chain, together with stapling heads with stapling elements (drivers, bending means) fitted thereon obtain the energy for their movements from a common power source. In order to realize the necessary movement of the stapling carriage, it is necessary to use crank mechanisms.

U.S. Pat. No. 6,142,354 (see European published patent specification EP 0 956 974 A1), by way of example, describes a gathering stapler with variable chain pitch and the drive mechanism thereof. This is a drive mechanism which has a first gear mechanism for driving the apparatus for stapling the products and a second gear mechanism for driving the collecting chain, on which the products are conveyed. A changeover arrangement with at least two fixed transmission ratios is provided for the two gear mechanisms in order for it to be possible to process at least two formats. The two subassemblies obtain their energy from a common drive cam.

U.S. Pat. No. 6,142,353 (see European published patent specification EP 0 958 942 A1) discloses a gathering stapler which has a common power source for the collecting chain and the simultaneously operating stapling carriage. Provided at the same time are a first drive for the stapling-carriage displacement and a second drive for the displacement of the bending means and the displacement of the driver.

The difficulty that is common to all such gathering staplers is that the profile of the oscillation movement of the stapling carriage, this being realized by means of a crank mechanism, has to be adapted to the constant speed profile of the collecting chain for carrying out the stapling process. In order to realize the movements, this problem may be solved mechanically by the use of diverse gear mechanisms and cam plates which obtain energy from a common power source. This purely mechanical solution, however, has considerable disadvantages: a rigid coupling of the drives limits the variability of the coordination of the movement sequences which influence the stapling process. It has a performance-limiting effect and results in high design outlay. It likewise has a disadvantageous effect on the increased changeover work involved in altering the movement sequences in relation to one another. For example, the wider collecting-chain pitch which is necessary for processing larger formats results in a greater collecting-chain speed. A larger crank radius of the crank mechanism of the stapling carriage results in critical speed and/or acceleration profiles for the stapling carriage, as a result of which contouring errors are produced. This problem cannot be eliminated by using a flywheel as a rotational energy store. Over and above this, such a flywheel makes inching operation more difficult. There are likewise then difficulties in stopping the machine immediately in the event of an emergency.

### BRIEF SUMMARY OF THE INVENTION

The object of the present invention is to provide a gathering stapler which overcomes the above-noted deficiencies and disadvantages of the prior art devices and methods of this general kind, and which achieves improved adaptation of the speed profiles of the collecting-chain movement and of the stapling-carriage movement.

With the above and other objects in view there is provided, in accordance with the invention, a gathering stapler with a plurality of mutually interconnected subassemblies including at least the following: a stapling carriage, a collecting chain, a stapling-displacement configuration, a delivery, and an ejector; at least two of the subassemblies having a separate and dedicated drive each; controllable motors forming power sources for the dedicated drives; and control units connected to and operatively associated with each of the motors, the control units synchronizing a movement of one of the subassemblies with a movement of at least one other of the subassemblies.

With the above and other objects in view there is also provided, in accordance with the invention, a method of driving a gathering stapler as described above. The novel method comprises the following steps:
separately driving at least two of the subassemblies, each with a separately controllable drive;
commanding movements of the subassemblies driven in each case by controllable motors, with an electronic control unit;
synchronizing a movement of one separately driven subassembly with a movement of at least one other separately driven subassembly; and
executing a variable collecting-chain movement adapted to a simultaneous operation of the stapling carriage.

Alternatively, the method may comprise the following steps:
separately driving at least three of the subassemblies, each with a separately controlled drive;
commanding movements of the subassemblies driven in each case by controllable motors, with an electronic control unit;
synchronizing movements of the separately driven subassemblies with a machine cycle; and
synchronizing a movement of the separately driven delivery and ejector subassemblies to produce the same transfer conditions for the product irrespective of the number of machine cycles.

In accordance with a preferred embodiment, a gathering stapler has at least one controllable motor for the crank mechanism of the stapling carriage and a controllable motor for the collecting chain. These power sources are typically servomotors. Using a servomotor for the crank mechanism of the stapling carriage and the bending arrangement, however, shortens the amount of time in which the stapling heads are at the same speed as the collecting chain, that is to say in which staples can be shot into the product. In order to extend the period in which the stapling heads and the collecting chain are at essentially the same speed in terms of magnitude and direction, it is also necessary for the collecting chain to be operated by a separate controlled motor, in particular a servomotor. The driving characteristics of this motor are coordinated correspondingly with the drive of the crank mechanism of the stapling carriage, with the result that it is possible for the stapling elements to receive in a clamped state from the carry-along element of the collecting chain the product which is to be stapled, to drive in, and fold over, the staple and to release the stapled product again to the carry-along elements of the collecting chain.

In order to realize the movement of the stapling carriage and blade carriage, the motor is activated such that, in conjunction with the phase positions of the two crank mechanisms being offset in relation to one another, low-vibration and quiet running of the gathering stapler is achieved. Such activation may also be described as an “electronic cam plate.” The movement of the collecting chain is adapted to, or synchronized with, the simultaneous operation of the stapling carriage during the stapling process by the associated motor also being activated differently. It is thus very easy to realize a collecting-chain path which can be altered in a cyclic or atactic (non-cyclic) manner.

It is likewise possible to predetermine for the individual machine-cycle periods, different subassembly-movement sequences which, at the end of each cycle, return to a common starting state. It is possible here, in particular, for the simultaneous operation of the stapling carriage and the movement of the collecting chain and the stapling-displacement configuration to be synchronized such that for individual adjacent cycles different points in time are provided at which the product and stapling carriage are at the same speed in terms of magnitude and direction, with the result that stapling can be carried out at different positions on the product. A super-cycle is typically predetermined, this comprising two or more machine cycles where, in each individual machine cycle, stapling is carried out at a different position. This super-cycle is iterated when the machine is running. This makes it possible to achieve so-called offset stapling of the products.

In an advantageous development of the invention, in addition to the power sources for the stapling carriage and the collecting chain, a gathering stapler has further controllable motors for at least one of the following subassemblies: the stapling-displacement configuration, the delivery and the ejector.

The use of a controllable motor for the stapling-displacement configuration and the stapling elements (drivers, bending means) fastened thereon makes it possible for there to be both an interruption, for example cyclic stoppage at the top dead-center position, and a variable stapling-displacement profile, in order for the stapling elements, in particular, to be moved away more quickly from the product during loop stapling. A further controllable motor for the drawing-off elements of the delivery and a further controllable motor of the ejector, which conveys the products into the delivery, may be coordinated with one another in dependence on the format which is to be processed and the number of cycles. It is thus possible to synchronize the movement of the separately driven delivery and ejector so as to produce the same transfer conditions, in particular as far as position and speed are concerned, for the product or products irrespective of the number of machine cycles. A typical coordination consists in that, at the point in which the product is received from the ejector, the speed of the drawing-off elements of the delivery coincides with, or is close to, the speed of the product ejected from the ejector. This avoids, or minimizes, movement of the product relative to the drawing-off element. As a result, careful processing of the product is achieved, it is not possible for the product to be marked or damaged, and in particular tearing of the cover or of the outer sheet at the staples is avoided. At higher processing speeds, it is possible to realize an ejecting movement with delay, with the result that precise positioning of the product in the delivery is possible. Furthermore, the drawing-off elements of the delivery may be controlled such that the product is transported as quickly as possible from the region of the ejector in order to avoid the following product running onto it. This makes it possible to achieve a higher number of cycles, in particular, in the case of products of a large sheet width. The use of the abovementioned individual controllable motors of the gathering staplers is a precondition for automatic presetting both for the advantageous embodiment described and for the developments thereof.

The control units are typically designed, both for the preferred embodiment and for an advantageous development thereof, such that the motors are provided with motor controllers and motor-control end stages, at least one being equipped with a display and operating location. This is realized in particular using modern computing technology, such as microprocessors, a connection for the exchange of data and control signals, storage media and/or input and output units. Provision is made for means for detecting the rotational position and/or rotational speed to be used. The control units of the motors advantageously have a central control means.

Other features which are considered as characteristic for the invention are set forth in the appended claims.

Although the invention is illustrated and described herein as embodied in a gathering stapler with separate drives, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a view of a gathering stapler with separate drives according to the invention;

FIG. 2 is a perspective view of the drive of the stapling carriage;

FIG. 3 is a perspective view of the drive of the collecting chain;

FIG. 4 is a perspective view of the drive of the stapling-displacement configuration;

FIG. 5 is a perspective view of the drive of the delivery; and

FIG. 6 is a perspective view of the drive of the ejector.

### DETAILED DESCRIPTION OF THE INVENTION

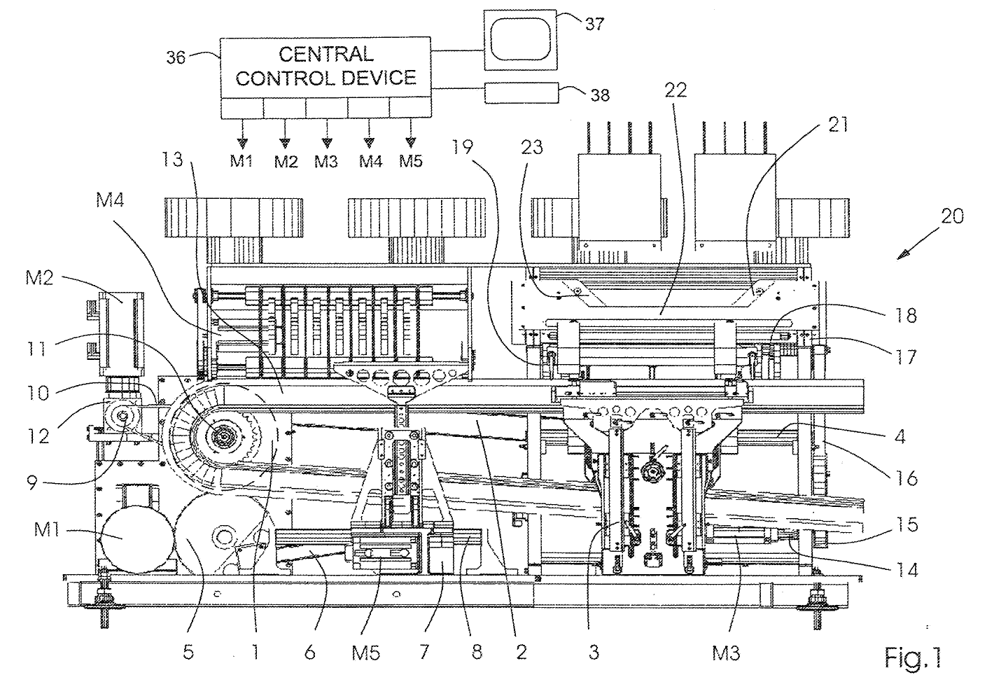

Referring now to the figures of the drawing in detail and first, particularly, to FIG. 1 thereof, there is seen a representative example of a gathering stapler with separate drives. A drive motor M1 drives a stapling carriage 3 by means of a crank 1 and a connecting rod 2. The stapling carriage 3 is mounted on a rectilinear thrust mechanism 4. A crank 5 and a connecting rod 6 make it possible for a blade carriage 7 to be moved horizontally back and forth along a rectilinear thrust mechanism 8. A drive motor M2 is provided for a collecting chain. The collecting chain 13 is driven by means of the toothed-belt wheel 9, i.e., a sprocket 9, a toothed belt 10, a toothed-belt wheel 11, and a chain wheel 12.

Provision is made for the two motors M1 and M2 to be activated such that the movements of the stapling carriage B1 and of the collecting chain B2 are coordinated or synchronized with one another. For this purpose, those speed profiles of the movements of the stapling elements and of the collecting chain B2 which are necessary for the stapling process are adapted to one another: as has already been mentioned, the period in which the stapling heads and the collecting chain are at essentially the same speed in terms of magnitude and direction is selected to be as large as possible.

Since the speed profile of the collecting chain B2 is more or less constant, it is possible, in principle, to utilize the corresponding motor M2 as a power source for the rest of the necessary movements. Advantageously, however, a further motor M3 is also provided for the stapling-displacement configuration B3 in order to allow, by means of a corresponding control means, a variable stapling-displacement profile or a stapling interruption. The gear mechanism 14, the toothed-belt wheel, the toothed belt 16, the toothed-belt wheel 17, the cam plates 18 and 19, the lever 20 and the tie rods 21 move the pushers 22, 23.

The drive motor M4 is provided for the delivery B4. The vertical movement of the ejector blade is realized with the aid of the drive motor M5 for the ejector B5. Depending on the format of the product to be processed and on the number of cycles, the movements of these subassemblies B4 and B5 may be coordinated with one another, with the result that it is possible to realize advantageous movement sequences, such as a quick drawing-off operation or an ejecting operation with delay.

FIG. 1 further includes a diagrammatic illustration of a central control device 36 which effects the controlled driving of the stapler assembly according to the invention. Each of the motors M1 . . . M5 has associated therewith a separate control unit. In this case, the individual control units are illustrated as part of the central control device 36. They may, however, be located directly at the respective motor and form part of the motor assembly. The control units also include, or are connected to, respective devices that detect the rotational position (angular position sensor, rotation sensor) and or the rotational speed of the motors.

The control units also include input/output units which allow programmable control of the drives. The control units may primarily be formed as motor controllers and/or a motor-control end stage. The central control device 36 also has a display device 37 (e.g. a computer screen) and an operating panel 38, including a keyboard, or the like.

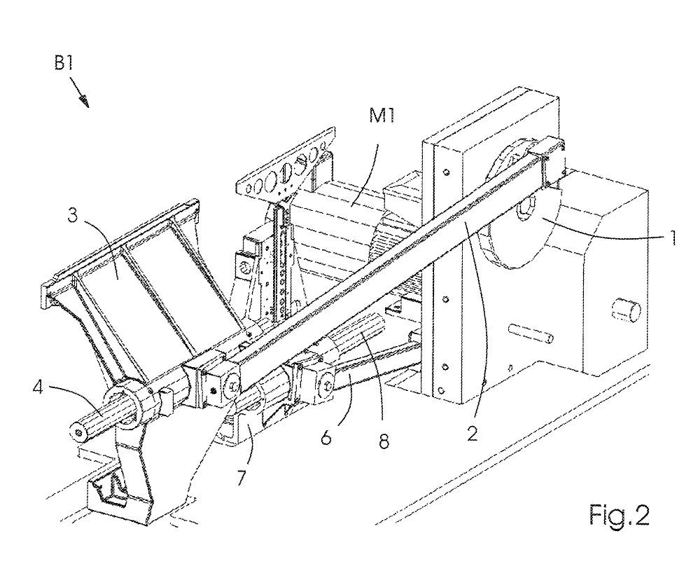

FIG. 2 shows the essential elements of the drive of the stapling carriage B1. The motor M1 drives the crank 1 which, by means of the connecting rod 2, realizes the horizontal movement of the stapling carriage 3 along the rectilinear thrust mechanism 4. At the same time, the drive motor M1 moves a crank which, in this view, is concealed and, along with the connecting rod 6, realizes the horizontal movement of the blade carriage 7 along the rectilinear thrust mechanism 8.

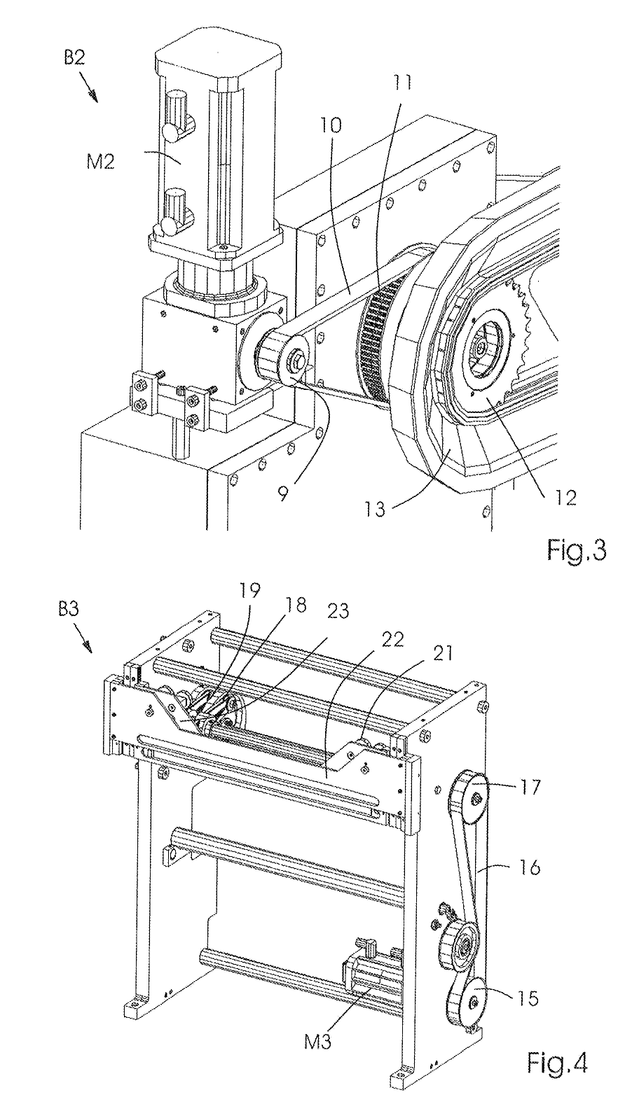

FIG. 3 illustrates the drive of the collecting chain B2. The motor M2 moves a toothed-belt wheel 9, which transmits the rotational movement to the toothed-belt wheel 11 by means of the toothed belt 10. The collecting chain 13 is thus driven via the interposed chain wheel 12.

FIG. 4 illustrates the drive for the stapling-displacement configuration B3. The motor M3 drives the toothed-belt wheel 15 by means of a gear mechanism. The toothed-belt wheel transmits its rotational movement to the toothed-belt wheel 17 with the aid of the toothed belt 16. This drives the cam plates 18, 19, which, by means of levers and tie rods 21, move the pushers 22 and 23 for the stapling elements.

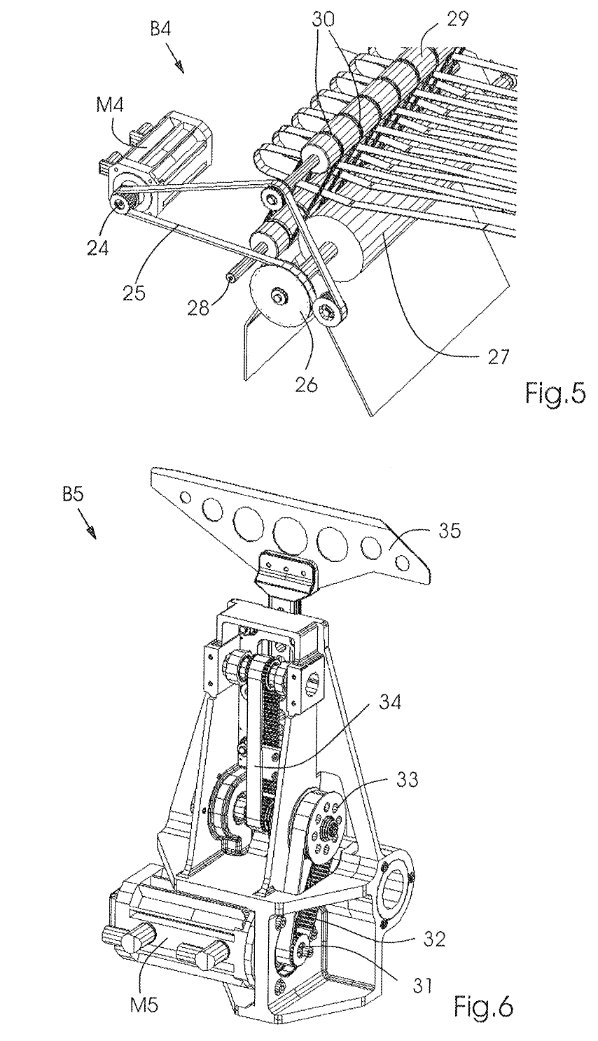

FIG. 5 shows the drive for the drawing-off elements of the delivery B4. The motor M4 drives the toothed belt 25 by means of a toothed-belt wheel 24. The transmission of force to the toothed-belt wheel 26 results in a rotational movement of the roller 27. At the same time, the toothed-belt wheel 28 causes the roller 29 to rotate in order, with the aid of the belts 30, to receive the ejected copies.

Finally, FIG. 6 shows the drive of the ejector B5. The motor M5 causes a toothed-belt wheel 31 to rotate. The toothed belt 34 is driven via the toothed belt 32 and the gear mechanism 33. The toothed belt 34 realizes the vertical oscillation movement of the ejector blade 35, i.e., the ejector stroke.

1. A method of driving a gathering stapler having a plurality of subassemblies including a stapling carriage, a collecting chain, a stapling-displacement configuration, a delivery, and an ejector, the method which comprises:
separately driving at least two of the subassemblies, each with a separately controllable drive;
commanding movements of the subassemblies driven in each case by controllable motors, with an electronic control unit;
synchronizing a movement of one separately driven subassembly with a movement of at least one other separately driven subassembly; and
executing a variable collecting-chain movement adapted to a simultaneous operation of the stapling carriage.

2. The method according to claim 1, which comprises cyclically altering the variable collecting-chain movement.

3. The method according to claim 1, which comprises acyclically altering the variable collecting-chain movement.

4. The method according to claim 1, which comprises:
effecting cycle-dependent movement of the stapling carriage, and a movement of the stapling-displacement configuration and of the collecting chain, which is different for individual machine-cycle periods and, at the end of each cycle, returns to a common starting state;
synchronizing the movement of the stapling carriage, the movement of the stapling-displacement configuration and the movement of the collecting chain such that for individual adjacent cycles, at different points in time, a respective product and the stapling carriage have speed profiles adapted to one another; and
carrying out a stapling operation at different positions on the product.

5. A method of operating a gathering stapler operating at a given machine cycle and having a plurality of subassemblies including a stapling carriage, a collecting chain, a stapling-displacement configuration, a delivery, and an ejector, the method which comprises:
separately driving at least three of the subassemblies, each with a separately controlled drive;
commanding movements of the subassemblies driven in each case by controllable motors, with an electronic control unit;
synchronizing movements of the separately driven subassemblies with a machine cycle; and
synchronizing a movement of the separately driven delivery and ejector subassemblies to produce the same transfer conditions for the product irrespective of the number of machine cycles.
